(19) United States
(12) Patent Application Publication
(10) Pub. No.: US 2009/0321245 A1
(43) Pub. Date: Dec. 31, 2009

(54) GENERATION OF COUPLED PLASMA DISCHARGES FOR USE IN LIQUID-PHASE OR GAS-PHASE PROCESSES

(76) Inventors: Vladimir Tarnovsky, Fair Lawn, NJ (US); Milan Begliarbekov, Brooklyn, NY (US); George Wohlrab, Secaucus, NJ (US); Christos Christodoulatos, Basking Ridge, NJ (US); Weidong Zhu, North Arlington, NJ (US)

Correspondence Address: GREENBERG TRAURIG, LLP, 200 PARK AVE., P.O. BOX 677, FLORHAM PARK, NJ, 07932, US

(21) Appl. No.: 12/471,037

(22) Filed: May 22, 2009

Related U.S. Application Data
(63) Continuation-in-part of application No. 12/201,229, filed on Aug. 29, 2008.
(60) Provisional application No. 60/969,326, filed on Aug. 31, 2007.
(60) Provisional application No. 61/128,675, filed on May 23, 2008.

(51) Int. Cl. B01J 19/08; H05F 3/06

(52) U.S. Cl. 204/164; 422/310

(57) ABSTRACT

A method of stimulating chemical reactions within a fluid media uses a gas plasma ejected from a gas-buffered microhollow cathode discharge apparatus into the fluid media. The apparatus has an electrically-conductive housing with an electrode positioned therein such as to create air channels between the electrode and the housing. The electrode is electrically insulated from the housing except at a location near the plasma outlet. A DC voltage is applied across the electrode and housing to accelerate the plasma and eject it into the fluid media. In another aspect, the housing includes a cup portion and a conduit portion that are electrically isolated from each other. When a DC voltage is applied across the electrode and the conduit, the plasma is ejected and filamentous discharges occur between the cup and the conduit. Such multicavity coupled plasma discharges provide voltage amplification and DC pulses with rates in the nanosecond regime.

### CROSS-REFERENCE TO RELATED APPLICATIONS

This application is a continuation-in-part of U.S. patent application Ser. No. 12/201,229, filed on Aug. 29, 2008, the disclosure of which is incorporated herein by reference, which claims benefit of U.S. Provisional Patent Application No. 60/969,326, filed Aug. 31, 2007, and U.S. Provisional Patent Application No. 61/128,675, filed May 23, 2008, and further directly claims benefit of U.S. Provisional Patent Application No. 61/128,675, filed May 23, 2008, the disclosure of which is incorporated herein by reference.

### FIELD OF THE INVENTION

The present invention relates to the fields of plasma generation and chemistry.

### BACKGROUND OF THE INVENTION

As discussed in co-owned U.S. patent application Ser. No. 12/201,229 (published as U.S. Patent Application Publication No. 2009/0057131, and referred to hereinafter as “the '131 Publication”), the entire disclosure of which is incorporated herein by reference, a conventional plasma torch may be used to generate energized chemical species and electrons in liquid media through injection of non-thermal plasma (NTP). Currently, the interactions between non-thermal plasma (NTP) and liquid media are mainly utilized in water treatment. Such interactions are usually accomplished by the direct discharge of water and water plasma using various methods. Other approaches involve generating a direct current/alternating current discharge through a water/water vapor interface, or through gas bubbles. These approaches, however, require high-voltage pulses, with a corresponding high power consumption, and are limited by their low operating volumes. The approach described in the '131 Publication provides a plasma torch of simple, compact construction and a scalable method for operating such torches to generate reactive chemical species. However, the device disclosed in the '131 Publication produces only a single plasma discharge which, while more energy-efficient than discharges produced by other methods, limits the average energy of the plasma-activated species (PAS).

### SUMMARY OF THE INVENTION

In one aspect of the present invention, a microhollow cathode discharge (MHCD) apparatus is used to stimulate chemical reactions within a fluid media by injecting plasma-activated species (PAS) in a gas carrier (i.e., a gas plasma) into the fluid media. In an embodiment according to this aspect of the present invention, the MHCD apparatus includes an electrically-conductive housing having a gas inlet and a gas outlet. An electrode is embedded in the housing between the gas inlet and gas outlet. The electrode has a bore with an electrically-conductive surface and is otherwise electrically insulated from the housing except at a location near the plasma outlet. The insulation is arranged so as to create a gas channel between the insulation and the housing.

Gas plasma is generated in a plasma reactor that is electrically-isolated from the MCHD apparatus and provided at the gas inlet at a sufficient pressure to drive the plasma through the bore of the electrode and air channel. A DC voltage is applied across the electrode and housing such that the electrode acts as cathode and the housing acts as an anode. The gas plasma is thus accelerated through the bore of the electrode and ejected into the fluid media where the PAS interact with the fluid, creating energized chemical species.

In another aspect of the present invention, a multicavity coupled plasma discharge (MCPD) apparatus is used to eject a gas plasma into a fluid media at higher energies than may be achieved using an MHCD device. In one embodiment according to this aspect of the invention, the MCPD apparatus is provided with a nozzle assembly that includes an electrode, an electrode insulator around the electrode, an electrically-conductive conduit having a gas inlet, and an electrically-conductive cup having a gas outlet. A dielectric material between the conduit and cup electrically isolate them from each other. The electrode has a bore with an electrically-conductive surface, and is exposed near a gas outlet in the cup. Otherwise, the electrode is electrically isolated from the conduit by the electrode insulator and a gas channel defined between the electrode insulator and the conduit.

Gas plasma is generated in a plasma reactor that is electrically-isolated from the MCPD apparatus and provided at the gas inlet at a sufficient pressure to drive the plasma through the bore of the electrode and the air channel. A DC voltage is applied across the electrode and conduit such that the electrode acts as cathode and the conduit acts as an anode. The gas plasma is thus accelerated through the bore of the electrode and eject it into the fluid media. Further, filamentous electrical discharges occur between the cup and the conduit, which increases the average energy of the PAS ejected through the gas housing and produces packets of PAS at rates in the nanosecond regime.

### BRIEF DESCRIPTION OF FIGURES

For a better understanding of the present invention, reference is made to the following detailed description of the exemplary embodiments considered in conjunction with the accompanying drawings, in which:

FIG. 1 is a schematic diagram of a microhollow cathode discharge (MHCD) apparatus used in generating plumes that contain plasma-activated species (PAS) according to some embodiments of the invention.

FIG. 2 is a longitudinal cross-sectional view of a multicavity coupled plasma discharge (MCPD) device for generating plasma plumes.

FIG. 3 is a longitudinal cross-sectional view of the nozzle end of the MCPD apparatus of FIG. 2.

FIG. 4 is a graph of a voltage waveform of several plasma filaments generated in an MCPD apparatus like that of FIG. 2.

FIG. 5 is a bar graph presenting the breakdown voltages of the primary and secondary discharges from the nozzle end of an MCPD apparatus like that of FIG. 2 as a function of the different gasses feeding the discharges.

FIG. 6 is a plot of the frequency of power pulses at a secondary discharge in an MCPD apparatus like that of FIG. 2 as a function of input power supplied to the parent discharge.

FIG. 7 is a series of graphs illustrating the effects of changing input current on voltage, current and power modulation at a secondary discharge in an MCPD apparatus like that of FIG. 2 at a constant secondary gap distance.

FIG. 8 is a series of graphs illustrating the voltage, current and power modulation at a secondary discharge in the MCPD apparatus of FIG. 7 at a single input current and a constant secondary gap distance that is different than the secondary gap distance of FIG. 7.

FIG. 9 is a graph of the waveforms of electron filaments in a plume that contains PAS and of packets of highly-energetic spatially-confined electron bunches outside of the plume.

FIG. 10 is a graph of the distribution of electron energies at various distances outside of the plume addressed by FIG. 9.

### DETAILED DESCRIPTION OF THE INVENTION

### Injection of Plasma-Activated Species (PAS) into Fluid Media

In one aspect of the present invention, a type of plasma injection device known as a microhollow cathode discharge (MHCD) apparatus is used as part of a conventional plasma torch to provide a simple and convenient non-thermal plasma (NTP)-fluid interface system for the direct injection of plasma-activated species (PAS) into a fluid medium, thus improving the overall efficiency of the plasma-medium interaction and reducing the power needed to generate energized chemical species compared to methods in which the water is ejected through the MCHD. The NTP, also referred to herein as a “gas plasma”, generally consists of PAS in a carrier gas. The term “gas plasma”, however, need not be limited to NTPs. MHCD apparatuses, in general, are discussed in U.S. Pat. No. 6,433,480, the disclosure of which is incorporated herein by reference.

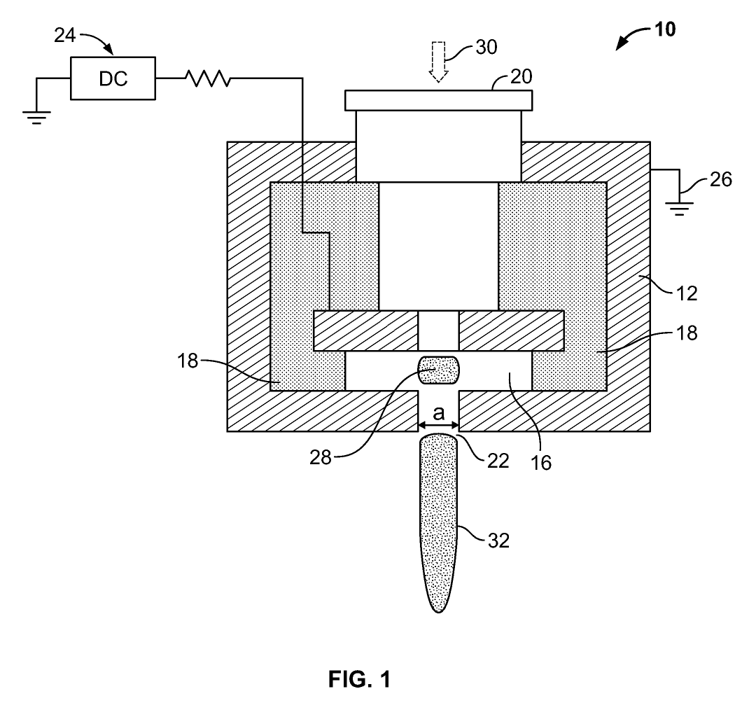

FIG. 1 illustrates a MHCD apparatus 10 of the general type used in some embodiments of the present invention according to its first aspect. The MHCD apparatus 10 comprises an electrically-conductive cup-like gas-buffered housing 12; an embedded electrode 16; an electrical insulator (or dielectric) 18 arranged to provide gas flow paths (not shown) through and around the embedded electrode 16; a gas inlet 20; and a gas outlet 22, which, preferably, is a nozzle. The effective diameter “a” of the gas outlet 22 will typically be on the order of 1 mm. The housing 12 and the embedded electrode 16 are electrically biased to act as anode and cathode, respectively, which may be achieved by connecting the embedded electrode 16 to a direct current (DC) power source 24 and the housing 12 to electrical ground 26. Alternatively, the embedded electrode 16 may be connected to the DC power source 24 and the housing 12 connected to another, separate DC power source (not shown).

A NTP discharge 28 is generated separately in a plasma reactor (not shown) and enclosed in the gas-buffered housing 12. Any electrically-isolated cup-like structure within or outside a plasma reactor may perform as a gas-buffered housing 12, as long as it is electrically isolated from the plasma reactor and allows gas flow to exit through the gas outlet 22. The gas-buffered housing 12 may be integral to the plasma reactor. Arrow 30 indicates a gas plasma (also “gas plasma 30”) entering the housing 12 through the gas inlet 20. A plume 32 that contains PAS driven by the flow of gas plasma 30 is shown exiting the gas outlet 22. In concept, the source of the gas plasma is not critical to the invention, and a NTP may be used.

In operation, the gas outlet 22 may submerged into a liquid or the plume 32 may be ejected into the atmosphere or other gaseous media. Gas should be provided at the gas inlet 20 so as to maintain the pressure in the housing 12 equal to or higher than the overall pressure of the environment into which the plume 32 is ejected, so that the housing 12 is not flooded through the gas outlet 22 and the discharge plasma 28 in the housing 12 is sustained. The housing 12 expels gas as a mixture of inflow gas and PAS.

When the gas outlet 22 is submerged in a liquid, the PAS may then interact with the liquid on the surfaces of gas bubbles expelled from the gas outlet 22, or with micro-liquid droplets that exist within gas bubbles created by interaction between the plume and the liquid. A quasi-steady gas cavity will also form at the gas outlet 22, causing a tremendous increase in the area of the liquid-gas interface, which leads to a much higher efficiency of conversion of the chemical species in the liquid.

When ejected into a gaseous media, such as the atmosphere, the PAS may convert constituent gas-phase molecules into reactive species, such as peroxides. The PAS may also convert chemical species at the surfaces of microdroplets or aerosols.

In a series of experiments discussed in the aforementioned '131 Publication, a DC micro-discharge plasma was generated using an MHCD apparatus of the type shown in FIG. 1 of the present application. Elements of the MHCD apparatus used in the experiments that correspond to those elements of FIG. 1 are referenced herein by the reference numbers used for such elements in FIG. 1. The metal housing 12, dielectric layer 18, and embedded electrode 16 were penetrated by a millimeter-size hole which served as a conduit for gasses and as an outlet 22 for a plume 32 of the gasses and PAS. Various gasses (air, O₂, N₂, Ar, Ne, He, and mixtures of such gasses) were used as the working gas for the plasma reactor and the gas flowing through the housing 12. The PAS were carried by the gas and directly injected into a liquid (such as tap water, de-ionized water, bio-enriched water, methanol, oil, etc.) through the gas outlet 22. When operated in ambient air, a clear plasma plume 32 (i.e., afterglow) was present and showed very little change in appearance when the gas outlet 22 was submerged into liquid.

The arrangement of the electrical circuit shown in FIG. 1 allowed almost 80% of the power from the power supply 24 to dissipate on the plasma discharge 28, improving the overall efficiency of the process. The voltage within the gas plume 32 and electromagnetic radiation at the gas outlet 22 were measured to be up to 25 V with respect to electrical ground 26. A negative ion current of 1 mA to 1 nA was detected at respective distances ranging from 0.1 cm up to 20 cm from the gas outlet 22.

When air was used as the working gas, direct oxidation of water was achieved in an extremely efficient way without discharging the water itself through the gas outlet 22. The hydrogen peroxide (H₂O₂) production rate was at least three times better than the best existing plasma-solution interaction method known to the inventors (i.e., capillary discharge in water, as discussed in Nikiforov, A. Yu., and Leys, C., “Influence of capillary geometry and applied voltage on hydrogen peroxide and OH radical formation in AC underwater electrical discharges”, Plasma Sources Sci. Technol. 16 (2007) 273-280, the disclosure of which is incorporated herein by reference).

A combination of two NTP-liquid interface systems may be opposed to each other with one gas-buffered housing biased positively to serve as a virtual anode and the other biased negatively to serve as a virtual cathode. With a flow of gasses from both systems, a gas discharge may be sustained within a quasi-steady state gas cavity generated between the opposing gas outlets.

The following, non-limiting, experimental example may be useful to further illustrate application of the invention in an embodiment according to its first aspect.

### Experimental Example

### H₂O₂ Production in De-ionized Water with Ambient Air as the Working Gas

PAS Generation: PAS were generated via a MHCD structure, similar to the MHCD apparatus 10 shown in FIG. 1, integrated with an air-pressure plasma generator as the PAS source. Direct current high voltage was supplied to the embedded electrode 16 at 20 mA. The grounded, gas-buffered metal housing 12 served as the other electrode. Ambient air was delivered into the air pressure plasma generator with an air compressor. The compressed air subsequently flowed through the openings in the electrodes 12, 16, where it was discharged within the high electric field created between the two electrodes 12, 16, pushing some of the PAS out of the gas outlet 22.

Introducing PAS into de-ionized water: The apparatus described above was set to create PAS continuously. As the apparatus was held stationary in a vertical position, a beaker containing 100 ml of de-ionized water was raised towards the gas outlet 22 of the gas-buffered housing 12 on a z-stage until the outer surface of the gas outlet 22 was about 2 cm below the surface of the de-ionized water. The flow of ambient air was controlled at a constant rate of about 30 ml/s and allowed to bubble out of the gas outlet 22. The PAS were introduced into the water continuously for about 15 minutes.

Measurement of the H₂O₂ concentration: The concentration of H₂O₂ in the treated water sample was evaluated using a HACH® hydrogen peroxide test kit (Model HYP-1; HACH Company, Loveland, Colo., USA). Ammonium molybdate solution was added to the treated de-ionized water sample, followed by the addition of HACH® Sulfite 1 reagent powder. After mixing, the color of the sample turned into a dark blue that was almost black. After 5 minutes, about 1 ml of the prepared sample was collected, and sodium thiosulfate titrant was added drop by drop until the color disappeared completely. Each drop of sodium thiosulfate titrant was counted as 1 mg/L of H₂O₂.

The H₂O₂ test showed that about 80 mg of H₂O₂/L of de-ionized water was produced during 15 minutes of direct introduction of PAS. The amount of H₂O₂ produced in similar tests would be dependent on air flow rate and electrical current.

pH test: The pH of the treated de-ionized water was tested using a standard pH paper test strip. No obvious color change was observed in tests made on the treated sample, indicating that there was no discernable deviation from the initial liquid pH of 7.

Ion current measurement outside of the gas outlet: The apparatus described above was held vertically, with ambient air as the working gas. Air flow and electrical current were maintained at about 30 ml/s and about 20 mA, respectively. An aluminum plate was connected to an ammeter to detect the ion current outside of the gas outlet 22. The distance between the surface of the aluminum plate and the outer surface of the gas outlet 22 was varied from 0.1 cm to 20 cm. The detected negative ion current was observed to decay with increased distance and ranged from 1 mA at a distance of 0.1 cm to 1 nA at 20 cm.

Application of Multicavity Coupled Plasma Discharges (MCPDS) to the Injection Of Plasma-Activated Species (PAS) into Fluid Media

In another aspect of the present invention, a multicavity coupled plasma discharge (MCPD) is used to inject PAS into fluid media at higher frequencies and higher average energies than may be achieved using a conventional plasma torch with an MHCD. A MCPD is a mode of plasma discharge in which a single primary discharge is used to initiate one or more secondary plasma discharges. In such embodiments of the present invention, multiple MCPDs are generated using a single direct current power source to initiate the primary discharge. The power needed to sustain the subsequent secondary discharges is drawn from the primary discharge by means of an active or a passive coupling scheme.

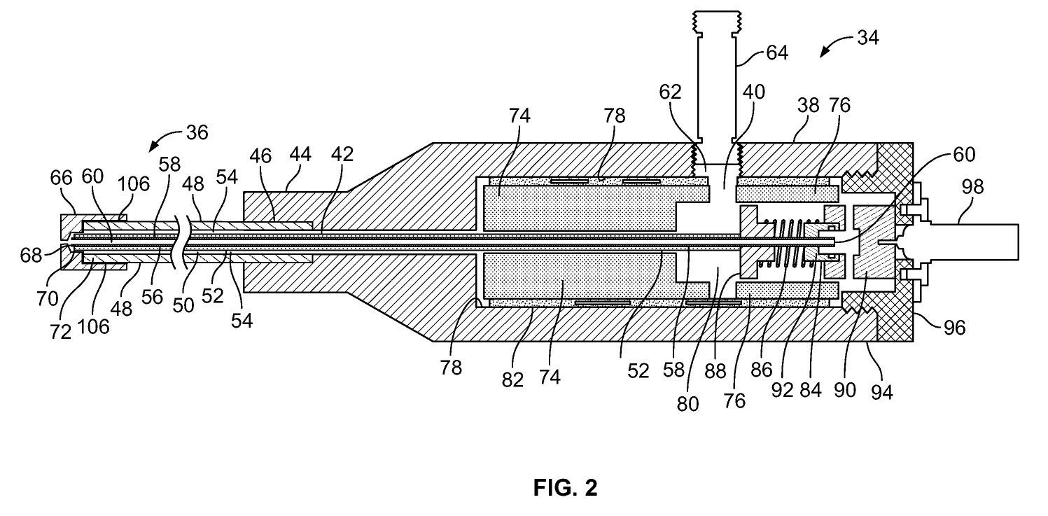

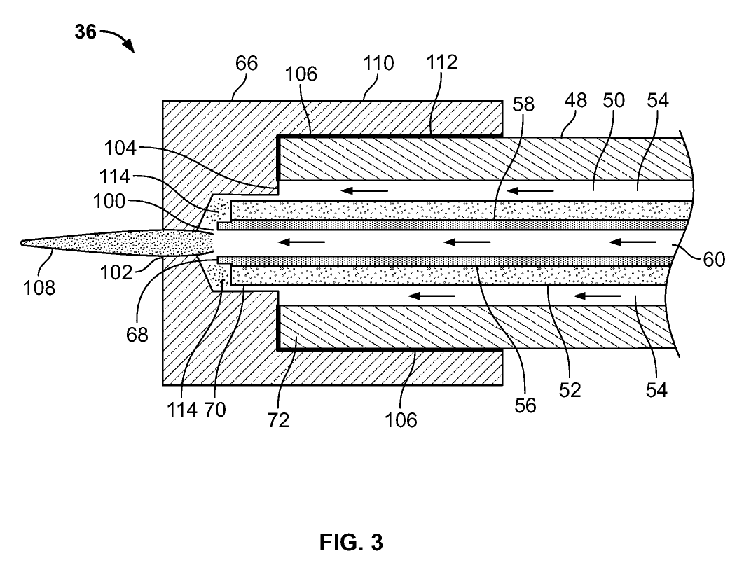

FIG. 2 depicts an MCPD apparatus 34 (referred to as an “MCPD torch” when used in conjunction with a PAS source) according to the present invention. FIG. 3 is depicts the nozzle assembly 36 of the MCPD apparatus 34.

Referring to FIGS. 2, and 3, the MCPD apparatus 34 comprises an electrically-insulating body 38 defining a cavity 40 therein and a longitudinal bore 42 extending from the cavity 40 through the distal end section 44 of the body 38. The distal end section 44 of the body 38 further defines a counterbore 46 to bore 42, which is arranged to closely receive an electrically-conductive extension tube 48 that extends away from the body 38 and has a respective longitudinal bore 50. The bore 50 of the extension tube 48 is arranged to receive a tubular electrical insulator 52 (referred to hereinafter as “cathode insulator 52”) such that an air channel 54 is defined between the extension tube 48 and the cathode insulator 52. The cathode insulator 52 has a respective longitudinal bore 56 that is arranged to closely receive an electrically-conductive tube 58 (referred to hereinafter as “cathode 58”) having a respective longitudinal cathode bore 60 (see FIG. 2). The cathode 58, cathode insulator 52 and extension tube 48 are further arranged such that said cathode 58 is electrically isolated from the extension tube 48 by the cathode insulator 52 and the air channel 54. The body 38 also defines an inlet bore 62 (see FIG. 2) extending from the cavity 40 through the body 38, which may be fitted with an inlet connector 64 (see FIG. 2) for receiving a carrier gas.

In some embodiments of the invention, the cathode bore 60 has an effective inner diameter of about 1 mm. In some embodiments of the invention, the cathode 58 is between about 180 mm and about 200 mm in length. In some embodiments of the invention, the cathode 58 is made of copper. In some embodiments of the invention, the cathode insulator 52 has an outer diameter of about 3 mm. In some embodiments of the invention, the cathode insulator 52 is made of ceramic. In some embodiments of the invention, the extension tube 48 has an inner diameter between about 4 mm and about 5 mm. In some embodiments of the invention, the extension tube 48 is made of copper.

Continuing to refer to FIGS. 2 and 3, the nozzle assembly 36 of the MCPD apparatus 34 is provided with a cup-like, electrically-conductive end cap 66 (hereinafter referred to as the “anode cup 66”) that is arranged to receive a distal end 68 of the cathode 58, a distal end 70 of the cathode insulator 52, and a distal end 72 of the extension tube 48. The arrangement and function of the anode cup 66 are discussed below in greater detail with respect to FIG. 3.

Continuing to refer to FIG. 2, the MCPD apparatus 34 also comprises one or more electrically-insulating bodies, represented in FIG. 2 by annular insulating bodies 74, 76. The insulating bodies 74, 76 are arranged to closely fit with an interior wall 78 of the body cavity 40, and define a chamber 80 within the cavity 40 that is in fluid communication with the air channel 54, the cathode bore 60, and the inlet bore 62. If desired, a layer of an electrically-insulating material, such as a shrink wrap 82, may be provided between the insulating bodies 74, 76 and the interior wall 78 of the body cavity 40. Further, the insulating bodies 74, 76 are arranged to receive the cathode insulator 52 and cathode 58. The insulating bodies 74, 76 are also arranged to operably receive an electrically-conductive cathode contact cup 84, a spring 86, a ceramic stop washer 88, and a high-voltage contact washer 90.

It may be seen that the cathode insulator 52 and cathode 58 extend into the chamber 80 defined by the insulating bodies 74, 76. The ceramic stop washer 88 is secured within the chamber 80. The cathode 58 passes through the ceramic stop washer 88 and is mechanically joined to the cathode contact cup 84 near a proximal end 92 of the cathode 58, such that the cathode bore 60 remains open. The spring 86 is positioned between the ceramic stop washer 88 and cathode contact cup 84 so as to provide a resilient mechanical connection between them. The arrangement of the ceramic stop washer 88, spring 86, and cathode contact cup 84 is such that the cathode 58 is suspended within the cavity 40 of the MCPD apparatus 34 and remains centered within the extension tube 48. The cathode contact cup 84 is also positioned near a proximal end 94 of the body 38, for reasons discussed further hereinbelow.

At the proximal end 94 of the body 38, the cavity 40 is closed by an electrically-insulating end cap 96 to which the high-voltage contact washer 90 is attached. A high-voltage connector 98 for connection to a high-voltage source (not shown) extends through the end cap 96 such that it is in electrical communication with the high-voltage contact washer 90. The cathode contact cup 84 is in contact with the high-voltage contact washer 90, and such contact is maintained through action of the spring 86. The end cap 96 is arranged such that it may be turned to move the high-voltage contact washer 90 and cathode contact cup 84 in a longitudinal direction, and thus adjust the position of the distal end 68 of the cathode 58 relative to the anode cup 66.

Reference numbers used throughout the remainder of the specification should be read with respect to FIG. 3. Referring to FIG. 3, the anode cup 66 is arranged to define a cavity 100 (hereinafter referred to as the “anode cup cavity 100”) for receiving the distal end 68 of the cathode 58 and the distal end 70 of the cathode insulator 52. The anode cup 66 also includes a nozzle opening 102 that provides a fluid connection between the anode cup cavity 100 and the environment of the anode cup 66, and that may serve as an outlet for gas and plasma; and an abutment 104 that is adjacent to the anode cup cavity 100 and may receive thrust from the distal end 72 of the extension tube 48 when the distal end 72 is inserted into the anode cup 66. In the assembled nozzle assembly 36, the distal end 68 of the cathode 58 and the distal end 70 of the cathode insulator 52 are suspended within the anode cup cavity 100, by the means that have been discussed with respect to FIG. 2, so as to allow fluid communication between the air channel 54 and the nozzle opening 102. In some embodiments of the nozzle assembly 36, the distal end 68 of the cathode 58 extends outside of the distal end 70 of the cathode insulator 52, but not so far as to contact the anode cup 66. Gas flow is directed via the air channel 54 and cathode bore 60 to the anode cup cavity 100 (as shown by the arrows in FIG. 3) causing gas and PAS to be continuously flushed through the nozzle opening 102.

In some embodiments of the invention, the nozzle opening 102 has an effective diameter between about 0.8 mm and about 1 mm. In some embodiments of the invention, the nozzle opening 102 has a length between about 1.2 mm and about 1.4 mm. In some embodiments of the invention, the anode cup cavity 100 has an effective diameter between about 3 mm and about 4 mm. In some embodiments, the anode cup cavity 100 has a length between about 3 mm and about 4 mm. In some embodiments, the anode cup cavity 100 is made of brass.

The extension tube 48 and the anode cup 66 are separated by a gap (not shown) containing a dielectric material 106. In some embodiments, the dielectric material 106 is a liquid or solid material that also acts as a seal between the extension tube 48 and the anode cup 66. In other embodiments, the distal end 72 of the extension tube 48 is set back from the abutment 104 so as to provide fluid communication between the air channel 54 and the environment of the nozzle assembly 36 between the extension tube 48 and the anode cup 66. In such embodiments, a portion of the gas flowing through the air channel 54 may be diverted to flow between the anode cup 66 and extension tube 48 and into the environment. In such embodiments, the gas may serve as the dielectric material 106. It may be observed that, because of the arrangement of the nozzle assembly 36, the gas that serves as the dielectric material 106 may be that same gas that drives the primary discharge (i.e., PAS plume 108). Reference numbers not previously mentioned with regard to FIG. 3 indicate the outer surface 110 of the anode cup 66; the inner surface 112 of the anode cup 66; and an area of filamentary discharge 114 in the anode cup cavity 100, all of which are discussed elsewhere hereinbelow.

The presence of a dielectric material 106 between the extension tube 48 and the anode cup 66 has the effect of electrically-decoupling the anode cup 66 from the extension tube 48. For comparison, in the MHCD apparatus 10 of FIG. 1, the anode (i.e., the housing 12) is electrically grounded, whereas in the MCPD apparatus 34, the anode cup 66 is floated (i.e., not electrically connected to the extension tube 48) and the extension tube 48 is grounded. In this regard, the anode cup 66 and extension tube 48 could be considered to be components of a cup-like housing, such as the housing 12 of FIG. 1, that have been electrically isolated from each other by the dielectric material 106. Such an arrangement does not affect the primary discharge (i.e., plume 108 of FIG. 3), because the anode cup 66 acts as an anode relative to the cathode 58. However, the anode cup 66 itself acquires a high voltage. When a sufficiently-high voltage is reached, the anode cup 66 becomes a virtual cathode for a secondary discharge to the grounded extension tube 48 across the dielectric material 106 to produce a discharge to ground that has a high frequency, high voltage, and high instantaneous current. In effect, the MCPD apparatus 34 becomes a highly compact and efficient direct current power modulator, capable of delivering up to 100 W over a half cycle of 5-10 nanoseconds.

The secondary discharge may be a series of filamentary discharges or, in some cases, a continuous arc discharge. Depending on the distance between the anode cup 66 and the extension tube 48 and the dielectric properties of the dielectric material 106, the secondary discharge may be either an arc or a high-frequency filamentary discharge. The pulse frequency of the filamentary discharge between the anode cup 66 and extension tube 48 can be adjusted according to the dielectric properties of the dielectric material 106, the input current, or the spacing between the anode cup 66 and extension tube 48.

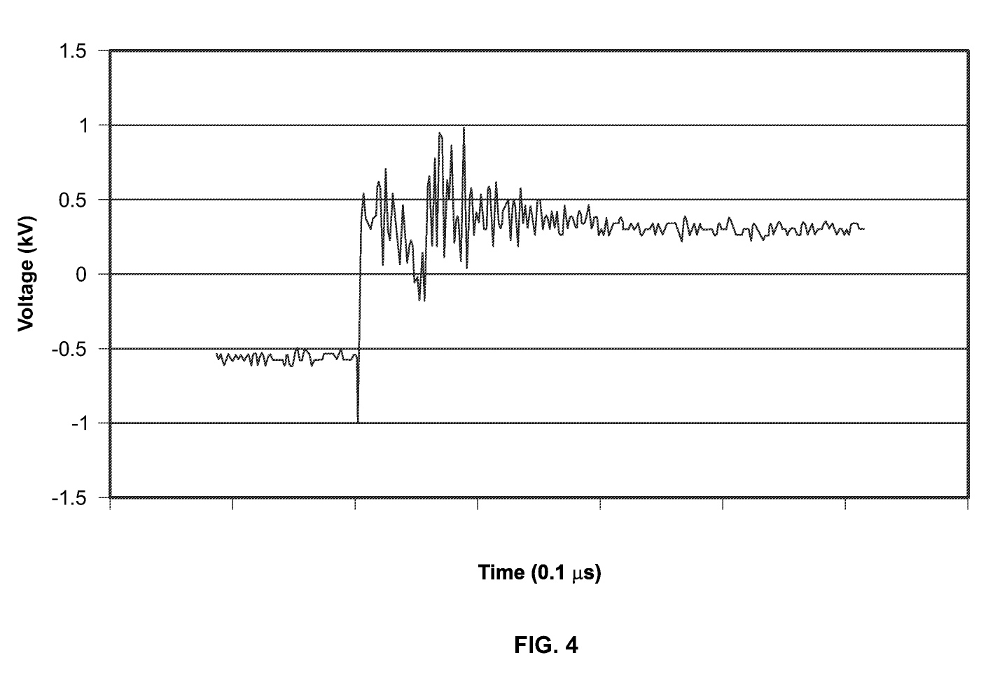

To aid in understanding the formation of secondary discharges, FIG. 4 shows the voltage waveform of several plasma filaments. Without being limited by theory, it appears that the microsecond oscillation that determines the envelope shape of FIG. 4 arises from fundamental instabilities within the plasma caused by the presence of the charged cathode 58 inside the anode cup 66. The electric field of the negatively biased cathode 58 creates a net negative charge on the outer surface 110 of the anode cup 66 and a net positive charge on the inner surface 112 of the anode cup 66. When this charge is transferred to the grounded extension tube 48, a net positive charge is created on the outer surface 110 of the anode cup 66 by the deficit of negative charges that were removed by the plasma. The negative charges, however, are subsequently replenished via a charge transfer from the primary discharge 108. Doing so gives rise to the microsecond lifetime of the filament bunches, as seen in FIG. 4. It should be noted that the power pulses only occur if the secondary discharge across the dielectric material 106 operates in a filamentary mode. If the anode cup 66 is unable to sustain a filamentary discharge, the secondary discharge operates in an arc mode that does not give rise to power pulses.

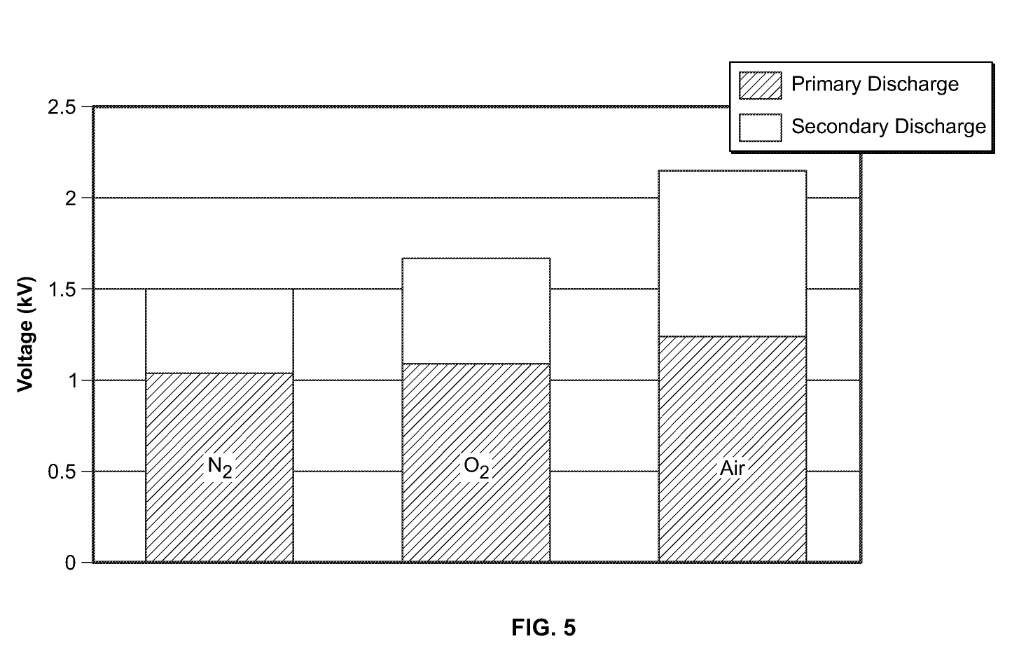

FIG. 5 is a bar graph presenting the breakdown voltages of both the primary and secondary discharges in relation to different gasses that may be used as dielectric material 106. The lower portions of the bars in FIG. 5 represent the voltages drawn from the power supply (i.e., the voltage required to sustain the primary discharge). The total height of each bar (i.e., the sum of the lower and upper portions of the bar) represents the total voltage on the anode cup 66. The upper portions of each bar represent the additional voltage on the anode cup 66 that is generated by the secondary discharge. Without being limited by theory, it appears that the additional voltage is created from accumulation on the anode cup 66 as a result of charge transfer from the primary discharge 108. This additional voltage is not drawn from the power supply. Consequently the MCPD torch (i.e., an MCPD apparatus used in conjunction with a PAS source) behaves as a step-up transformer that modulates the voltage supplied to the primary discharge 108.

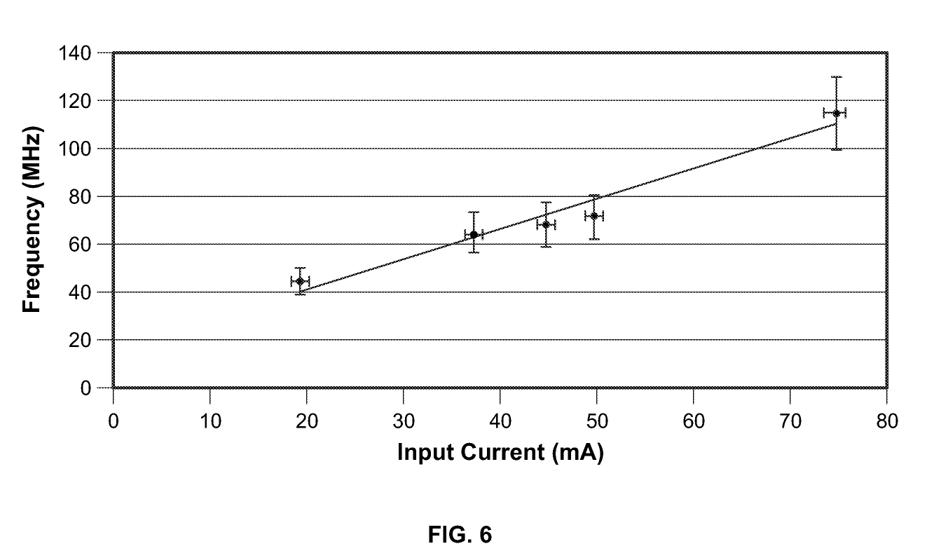

FIG. 6 shows the frequency of the power pulses across the dielectric material 106 as a function of input power supplied to the primary discharge 108. Without being limited by theory, it appears that larger input power replenishes the charge lost by the anode cup 66 in secondary discharge at a faster rate. FIG. 6 indicates that the power pulse frequency is directly proportionate to the input power.

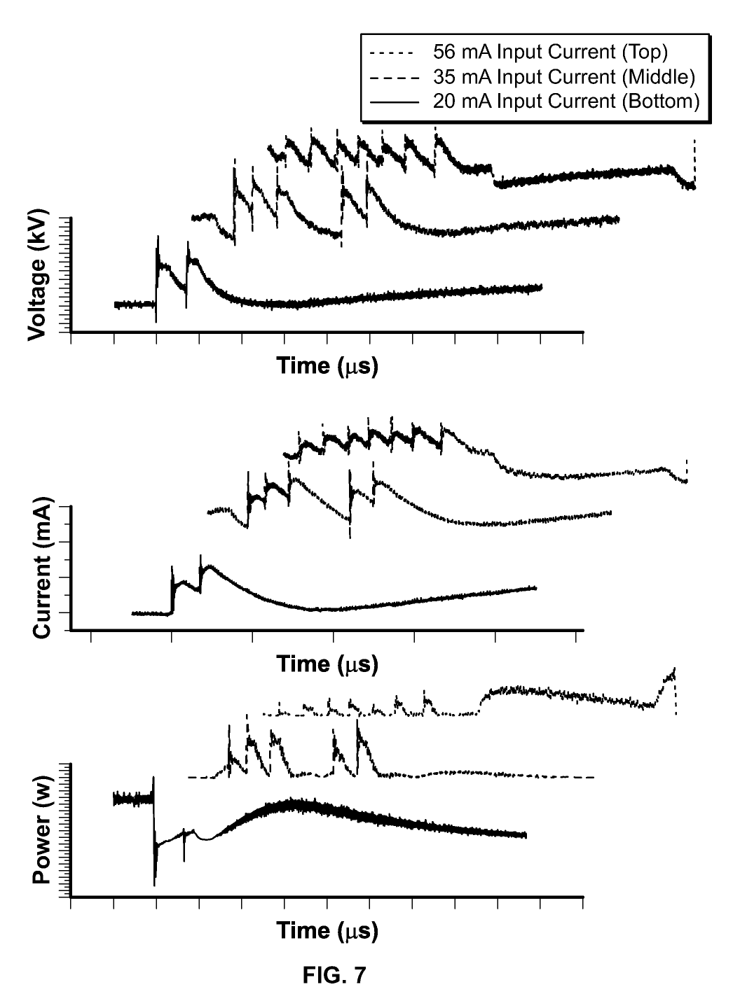

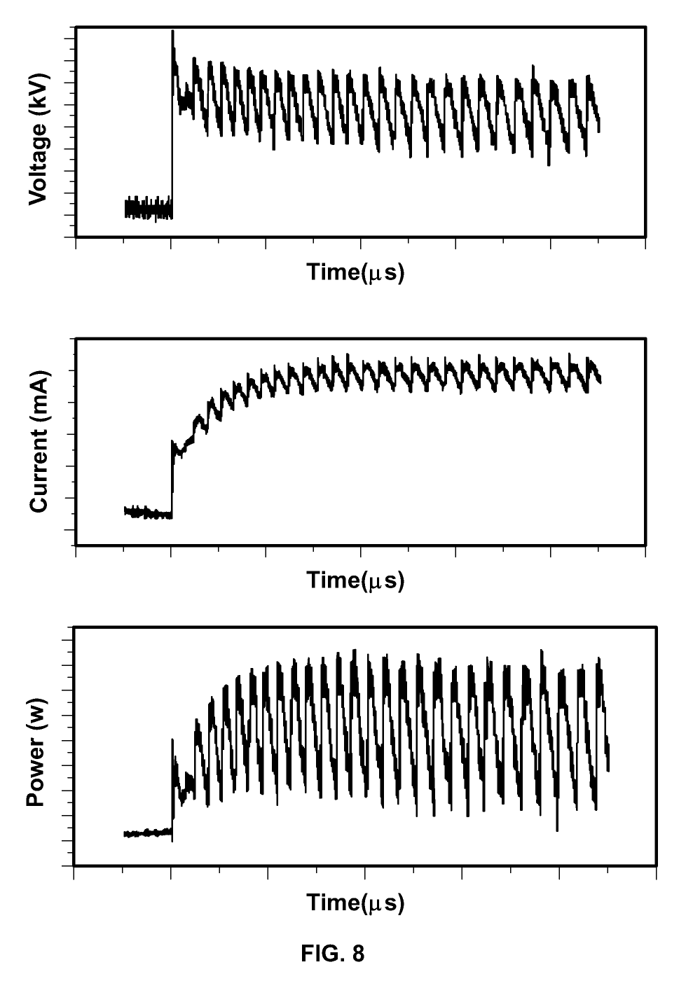

FIGS. 7 and 8 are series of graphs illustrating the effects of input current and secondary gap distance (i.e., thickness of the dielectric material 106) on voltage, current and power modulation at the secondary discharge when the dielectric material is air. FIG. 7 shows waveforms that result from secondary discharges at a secondary gap distance of 0.25 mm at input currents of 20 mA, 35 mA, and 56 mA. The bottom line in each graph of FIG. 7 shows the waveforms generated at the 20 mA input current. This configuration is able to sustain only two consecutive pulses in the high frequency regime. Consequently, the majority of the power is dissipated in a non-pulsed mode of the discharge. Supplying more current (i.e., at 35 mA, which is represented by the middle waveform and at 56 mA which is represented by the top waveform) across the 0.25 mm gap increases the number of pulses. However, the discharges across the 0.25 mm gap still exhibit a non-pulsed (i.e., micro-arc) component of the discharge. FIG. 8 shows waveforms that result from secondary discharges across a 1.5 mm gap at an input current of 45 mA. This combination of input current and secondary gap distance results in a stable power modulation waveform in the microwave regime. It will be obvious to those having ordinary knowledge of the relevant arts, and in view of the disclosures made herein, that the dielectric material, gap geometry and input current may be selected to generate secondary discharges at targeted power outputs and frequencies.

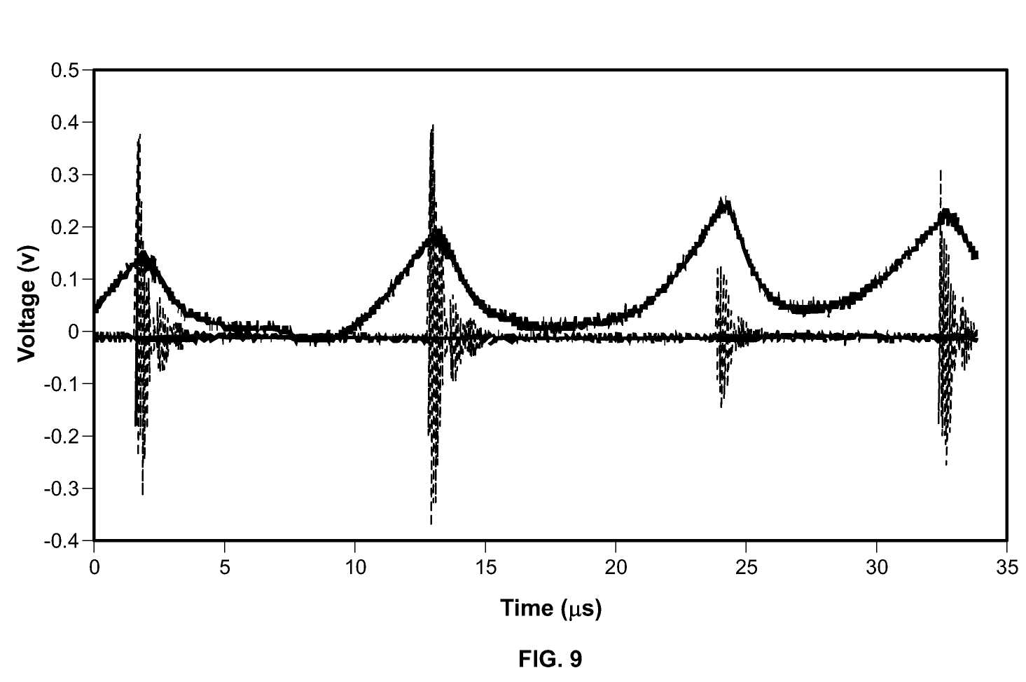

Based on the foregoing discussions regarding FIGS. 4-8, and referring to FIG. 3, it is also evident that filamentary discharges of electrons (hereinafter referred to as “electron filaments”) may occur between the cathode 58 and the anode cup 66 across gas present in the anode cup cavity 100. Such an area of filamentary discharge 114 is indicated in FIG. 3. As indicated by the waveforms of FIG. 9, such electron filaments give rise to the ejection of highly energetic spatially-confined electron bunches (hereinafter referred to as “electron bullets”) outside of the plasma plume 108.

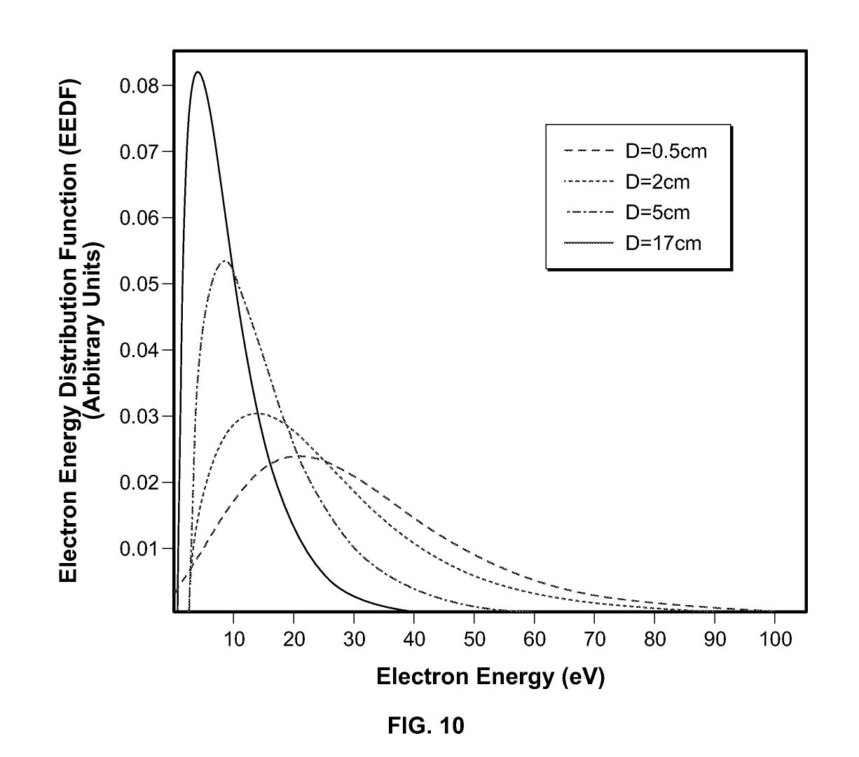

FIG. 9 demonstrates the simultaneous generation of electron filaments detected in a plasma from a MHCD torch (lower waveform) and electron bullets detected outside of the plasma. The frequency of electron bullets is about 0.5 to about 1.5 MHz. FIG. 10 presents the distribution of electron energies at various distances outside of the plasma plume 108, showing that the energy of the electron bullets is lower as distance from the plume 108 increases.

Further to the above discussion, experimentation has shown that the additional voltage drawn by secondary discharges in a MCPD torch results in about a three-fold increase in the frequency of filamentous discharges (i.e. about 1.5 to about 4.5 MHz) and a three-fold increase in average energy of the ejected electron bullets over the performance of a MHCD torch. Without being limited by theory, it appears that the ejection of electron bullets may be necessary to produce the chemical conversions observed in liquid media with an MHCD or MCPD torch. Thus, the ejection of electron bullets related to the secondary discharges of a MCPD torch would greatly enhance the rates of chemical conversion that can be achieved. Very low rates of conversion, if any, would be achieved in a micro-arc discharge regime.

As may be understood from the disclosures made herein, MCPDs make it possible to convert a DC-driven atmospheric pressure micro-flow discharge to a power modulator unit, thereby creating conditions for an additional source of energy (e.g., for a secondary plasma source), utilizing a single power supply. Beyond the embodiments disclosed in detail herein, this approach may be used to supply high-frequency voltages for other discharges using a single power supply, whether such discharges are located on a single device or on remote devices. One such application that has been demonstrated is the harnessing of the secondary discharge from an MCPD torch to power a MHCD torch. Air was used as the PAS carrier and dielectric material 106 in the MCPD torch. The anode cup 66 of the MCPD torch was connected to the cathode (i.e., embedded electrode 16 of FIG. 1) of the MHCD torch and the anode of the MHCD (i.e., housing 12 of FIG. 1) was connected to ground. Each of the MCPDs was provided with its own gas supply. The primary discharge from the MHCD torch was not continuous, but, rather, was a pulsed DC discharge, which is consistent with the provision of a pulsed power supply (i.e., the secondary discharge of the MCPD torch.

Other advantages include the provision of a high ratio of voltage amplification (e.g., a ratio of 1 to 20), and ultra-fast time compression (e.g., direct current pulse in the nanosecond regime). All of these advantages are achieved within a small-volume gap within the MCPD apparatus (i.e., within a volume of a few cubic centimeters). Further, in view of the disclosure of MCPD devices made herein, one having ordinary skill in the relevant arts would realize that MCPD devices generating multiple secondary plasma discharges may also be made.

It should be understood that the embodiments of the invention discussed herein are merely exemplary and that a person skilled in the relevant arts may make many variations and modifications without departing from the spirit and scope of the invention.

We claim:

1. A nozzle assembly for a plasma injection device, said nozzle assembly comprising:
an electrode defining an electrode bore therethrough, and having opposed first and second electrode end portions, said first electrode end portion defining a first opening of said electrode bore and said second electrode end portion defining a second opening of said electrode bore, said electrode bore having an exposed electrically-conductive surface and said first electrode end portion having an electrically-conductive outer surface, said second opening of said electrode bore arranged such that it may receive a gas;
an electrically-insulating electrode insulator arranged around said electrode such that an exposed portion of said outer surface of said first electrode end portion is not covered by said electrode insulator;
an electrically-conductive conduit defining a conduit bore therethrough, opposed first and second conduit end portions, said first conduit end portion defining a first end of said conduit bore and said second conduit end portion defining a second end of said conduit bore; said second end of said conduit bore being arranged to receive a gas, said conduit bore being arranged such as to receive said electrode and electrode insulator;
an electrically-conductive cup having opposed first and second cup end portions and defining a cup cavity, said first cup end portion having a first cup opening and said second cup end portion having a second cup opening that is larger than said first cup opening, said first and second cup openings in fluid communication with said cup cavity, said second cup end portion of said cup and said first conduit end portion arranged such as to electrically isolate said cup from said tube;
said electrode, electrode insulator, housing, and cup being arranged such that said electrode and electrode insulator extend through said housing bore such as to define an air channel between said electrode insulator and said tube, said air channel being in fluid communication with said first and second end of said conduit bore and said cup cavity, said electrode bore being in fluid communication with said cup cavity, said electrode being electrically isolated from said conduit by said electrode insulator and said air channel, said first electrode end portion and said electrode insulator extending into said cup cavity with the exposed portion of said first electrode end portion within said cup cavity and spaced away from said cup.

2. The nozzle assembly of claim 1, further comprising a dielectric material, wherein said second cup end portion and said first conduit end portion are arranged such as to define a gap between said second cup portion and said first conduit end portion, and said dielectric material is within said gap.

3. The nozzle assembly of claim 2, wherein said dielectric material is one of a liquid and a solid.

4. The nozzle assembly of claim 2, wherein said dielectric material is a gas and said gap is fluidly connected with said air channel and the environment outside of said nozzle assembly.

5. The nozzle assembly of claim 2, wherein said first opening of said first electrode bore has an effective diameter of about 1 mm.

6. The nozzle assembly of claim 3, wherein said first cup opening has an effective diameter in the range of about 0.8 mm to about 1 mm and a length in the range of about 1.2 mm and 1.4 mm.

7. The nozzle assembly of claim 3, wherein said cup cavity has an effective diameter in the range of about 3 mm to about 4 mm and a length in the range of about 3 mm to about 4 mm.

8. The nozzle assembly of claim 1, wherein said cup cavity is defined by said first cup end portion and said first conduit end portion resides in said second cup end portion.

9. The nozzle assembly of claim 1, further comprising means to movably position said first electrode end portion within said cup cavity.

10. The nozzle assembly of claim 1, wherein the exposed portion of the outer surface of the first electrode end portion encompasses the first cathode end portion.

11. A method of stimulating chemical reactions within a fluid media using a plasma-generating means for generating a gas plasma comprising a plasma-activated species in a carrier gas, a source of direct-current voltage, and a nozzle assembly for a plasma injection device, the nozzle assembly being electrically isolated from the plasma generating means and including an electrically-conductive housing defining a housing cavity inside the housing, first and second housing openings in the housing in fluid communication with the housing cavity, the first housing opening being smaller than the second housing opening, the housing being adapted to receive a gas through the second housing opening and eject a gas through the first housing opening, an electrode defining an electrode bore therethrough that has an electrically-conductive surface exposed between the first and second housing openings, an electrical insulator between the electrode and the housing, wherein the electrode, electrical insulator and housing are arranged such as to define an air channel between the electrical insulator and the housing, the air channel being in fluid communication with the first and second housing openings, and the electrode bore being in fluid communication with the first housing opening, said method comprising the steps of:
electrically connecting the source of direct-current voltage to one of the electrode and the housing;
making an electrical connection to the other of the electrode and the housing;
immersing the first housing opening in the fluid material;
generating a gas plasma in a gas carrier;
providing a first gas at a first mass flow rate at the electrode bore and a second gas at a second mass flow rate at the second housing opening such that a total mass flow rate consisting of the first mass flow rate and the second mass flow rate is sufficient to maintain a pressure at the first housing opening that is greater than the pressure exerted by the fluid media at the first housing opening, wherein either the first gas or both the first gas and the second gas includes the gas plasma; and
applying a direct-current voltage to said nozzle assembly by means of the source of direct-current voltage at an input current such that an electrical circuit is completed across the electrode, the gas plasma and the housing, thereby accelerating the gas plasma so as to eject the gas plasma through the first housing opening and into the fluid media.

12. The method of claim 11, wherein the electrode has an electrically-conductive outer surface exposed to the housing proximal the first housing opening and spaced away from the housing.

13. The method of claim 12, wherein the housing includes a cup portion and a conduit portion separated from each other so as to define a gap and a dielectric material within the gap such as to electrically isolate the cup portion from the conduit portion, the cup portion defining a cup cavity that is a portion of the housing cavity and the conduit portion defining a conduit bore that is another portion of the housing cavity, the first housing opening being defined by the cup portion and the second housing opening being defined by the conduit portion, the electrode being electrically isolated from the conduit portion by the electrical insulator and the air channel, and the electrically-conductive outer surface of the electrode being exposed within the cup cavity, wherein said step of electrically connecting the source of direct-current voltage to one of the electrode or the housing is performed such that the source of direct-current voltage is not connected to the cup portion, said step of making an electrical connection to the other of the electrode or the housing is performed such that the electrical connection is not made to the cup portion, and said step of applying a direct-current voltage to said nozzle assembly is performed such as to generate filamentous electrical discharges between the cup portion and conduit portion.

14. The method of claim 13, including the further steps of selecting a target frequency of the filamentous discharges, and selecting one or more of the dielectric material, the input current and a geometric arrangement of the gap, such that said filamentous electrical discharges are generated at about said target frequency.

15. The method of claim 14, wherein the gap is in fluid communication with said air channel and the environment outside of the nozzle assembly and said dielectric material is the second gas, said method including the further step of providing said second gas at a mass flow rate that is sufficient to maintain a pressure within the gap that is greater than the pressure in the environment adjacent to the gap.

16. The method of claim 11, wherein said step of making an electrical connection to the other of the electrode and the housing includes the step of electrically grounding the other of the electrode and the housing.

17. The method of claim 11, wherein said step of making an electrical connection to the other of the electrode and the housing includes the step of making an electrical connection between a second source of direct-current voltage and the other of the electrode and housing.

18. The method of claim 11, wherein the fluid media is a gas.

19. The method of claim 11, wherein the fluid media is a liquid.

20. The method of claim 13, said method including the further step of electrically connecting the cup portion of the nozzle assembly to an electrically-powered device so as to deliver intermittent direct current to said device.
